(19) United States
(12) Patent Application Publication
(10) Pub. No.: US 2026/0164321 A1
(43) Pub. Date: Jun. 11, 2026

(54) ACTIVATING AND DEACTIVATING MEASUREMENT GAPS IN A COMMUNICATION NETWORK SYSTEM

(71) Applicant: Samsung Electronics Co., Ltd., Suwon-si (KR)

(72) Inventors: Aby Kanneath ABRAHAM, Bangalore (IN); Jamsheed Manja PPALLAN, Bangalore (IN); Vinay Kumar SHRIVASTAVA, Bangalore (IN)

(21) Appl. No.: 19/414,936

(22) Filed: Dec. 10, 2025

Related U.S. Application Data
(63) Continuation of application No. PCT/KR2025/021272, filed on Dec. 10, 2025.

(30) Foreign Application Priority Data
Dec. 10, 2024 (IN) 202441077075
Dec. 11, 2024 (IN) 202441077310
Nov. 28, 2025 (IN) 2024 41077075

(51) Int. Cl. H04W 36/00

(52) U.S. Cl. CPC H04W 36/0094; H04W 36/00837

(57) ABSTRACT

A method and system for activation and deactivation of a measurement gap in a communication network system are provided. The method includes configuring a measurement gap and a condition for activation or deactivation of the measurement gap at the user equipment (UE), determining whether the condition for activation of the measurement gap is fulfilled when the measurement gap is deactivated or the condition for deactivation of the measurement gap is fulfilled when the measurement gap is activated, transmitting a request message to a network apparatus for activation of the measurement gap when the condition for activation fulfilled or for deactivation of the measurement gap when the condition for deactivation is fulfilled, receiving a response message from the network apparatus, and activating or deactivating the measurement gap based on the response message.

### CROSS-REFERENCE TO RELATED APPLICATION(S)

This application is a continuation application, claiming priority under 35 U.S.C. § 365(c), of an International application No. PCT/KR2025/021272, filed on Dec. 10, 2025, which is based on and claims the benefit of an Indian Provisional patent application number 202441077075, filed on Dec. 10, 2024, in the Indian Patent Office, of an Indian Provisional patent application number 202441077310, filed on Dec. 11, 2024, in the Indian Patent Office, and of an Indian Complete patent application number 202441077075, filed on Nov. 28, 2025, in the Indian Patent Office, the disclosure of each of which is incorporated by reference herein in its entirety.

### BACKGROUND

### 1. Field

The disclosure relates to a field of wireless communication. More particularly, the disclosure relates to a method and system for activation and deactivation of a measurement gap in a communication network system.

### 2. Description of Related Art

In wireless technologies like fifth generation (5G) new radio (NR), devices can move across different cells. Mobility is performed using a procedure called cell reselection in RRC_IDLE mode. In NR, mobility is performed using a procedure called handover in RRC_CONNECTED mode. Network controlled mobility applies to user equipments (UEs) in RRC_CONNECTED. It requires explicit radio resource control (RRC) signalling to be triggered by the next-generation node B (gNB) in NR. Handover in NR usually consists of three operations: handover preparation, handover execution and handover completion. The gNB may configure the UE to report measurements and based on the reported measurements or based on its own understanding of the network topology, the gNB will send RRC reconfiguration message to handover the UE to another cell called target cell from the source cell. The UE accesses the target cell and sends RRC reconfiguration complete message.

In an alternative way introduced in third generation partnership project (3GPP) NR release 16, the gNB may configure the UE with the execution conditions for triggering handover and once the execution conditions are satisfied, the UE may move to target cell and sends the RRC reconfiguration complete. In general, the UE releases the conditional handover after a handover. Similarly, in dual connectivity, the conditional primary secondary cell (PSCell) addition or conditional PSCell change configuration is released upon performing the PSCell addition or PSCell change. From 3GPP release 18 onwards, it is possible for the UE to store the conditional PSCell change configuration after a PSCell change.

3GPP release 18 introduced lower layers (layer 1 (L 1)/layer 2(L 2 )) triggered mobility (LTM) where the mobility is triggered using lower layer signalling (such as L2 signalling). It is possible for the UE to store the LTM configuration after an LTM cell switch.

Mobility including conditional mobility is performed based on the measurements. When the UE needs to measure inter frequency NR or inter-radio access technology (RAT) measurements or intra frequency measurements outside the active downlink (DL) bandwidth part (BWP) when synchronization signal block (SSB) is not completely contained in the active DL BWP or other cases where the UE cannot perform measurements and operations on the serving cells at the same time, UE may use measurement gaps. Measurement gaps are configured by the network (for example, gNB in NR) and there will not be any transmission or reception during the gap period, with some possible exceptions. Measurement gap configuration includes a gap offset, gap length, repetition period and measurement gap timing advance. Gap offset specifies the sub-frame where the measurement gap occurs. Gap length gives the duration of the gap while the repetition period defines how often the measurement gap can occur.

The measurement gaps create gaps in the reception (and transmission) for the UE and affects the throughput, latency and other key performance indicators. Currently there is no method to limit the measurement gaps to the scenarios where it is needed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for activation and deactivation of a measurement gap in a communication network system.

Another aspect of the disclosure is to configure the UE with the measurement configuration, the measurement gap configuration and with the conditions for activation of the measurement gap configuration.

Another aspect of the disclosure is to provide a method to allow the network to configure and the UE to perform interfrequency measurements for a subsequent mobility, such as subsequent LTM or subsequent handover or subsequent conditional PSCell addition or change (CPAC) without very high overhead of the unnecessary measurement gap operations.

Additional aspects will be set forth in part in the description which follows and, in part, will be apparent from the description, or may be learned by practice of the presented embodiments.

In accordance with an aspect of the disclosure, a method for activation and deactivation of a measurement gap in a communication network system is provided. The method includes receiving, by a user equipment (UE) from a network apparatus, a radio resource control (RRC) configuration message, wherein the RRC configuration message comprises at least one of a measurement gap, or a condition for activation or deactivation of the measurement gap at the UE, determining, by the UE, whether the condition for activation or deactivation of the measurement gap is fulfilled based on the measurement gap being deactivated or activated, transmitting, by the UE to the network apparatus, a request message for activation or deactivation of the measurement gap based on the condition for activation or deactivation of the measurement gap being fulfilled, receiving, by the UE from the network apparatus, a response message for activation or deactivation of the measurement gap based on the request message, and activating or deactivating, by the UE, the measurement gap based on the response message.

In accordance with another aspect of the disclosure, a method for activation and deactivation of a measurement gap in a communication network system is provided. The method includes generating, by a network apparatus, a measurement gap configuration, and a condition for activation or deactivation of the measurement gap at a UE, transmitting, by the network apparatus, a RRC configuration message to the UE, wherein the RRC configuration message includes at least one of the measurement gap configuration, or a condition for activation or deactivation of the measurement gap at the UE, receiving, by the network apparatus from the UE, a request message for activation or deactivation of the measurement gap based on the condition for activation or deactivation of the measurement gap being fulfilled, generating, by the network apparatus, a response message for activation or deactivation of the measurement gap based on the request message, and transmitting, by the network apparatus, the response message to the UE.

In accordance with another aspect of the disclosure, a UE for activation and deactivation of a measurement gap in a communication network system is provided. The UE includes memory, including one or more storage media, storing instructions, and at least one processor communicatively coupled to the memory, wherein the instructions, when executed by the at least one processor, cause the UE to receive, from a network apparatus, a radio resource control (RRC) configuration message, wherein the RRC configuration message comprises at least one of a measurement gap, or a condition for activation or deactivation of the measurement gap at the UE determine whether the condition for activation or deactivation of the measurement gap is fulfilled based on the measurement gap being deactivated or activated, transmit a request message to a network apparatus for activation or deactivation of the measurement gap based on the condition for activation or deactivation of the measurement gap being fulfilled, receive a response message from the network apparatus for activation or deactivation of the measurement gap based on the request message, and activate or deactivate the measurement gap based on the response message.

In accordance with another aspect of the disclosure, a network apparatus for activation and deactivation of a measurement gap in a communication network system is provided. The network apparatus includes memory, including one or more storage media, storing instructions, and at least one processor communicatively coupled to the memory, wherein the instructions, when executed by the at least one processor, cause the network apparatus to generate a measurement gap configuration, and a condition for activation or deactivation of the measurement gap at a user equipment (UE), transmit a radio resource control (RRC) configuration message to the UE, wherein the RRC configuration message comprises at least one of the measurement gap configuration, or the condition for activation or deactivation of the measurement gap at the UE, receive a request message from the UE for activation or deactivation of the measurement gap based on the condition for activation or deactivation of the measurement gap being fulfilled, generate a response message for activation or deactivation of the measurement gap based on the request message, and transmit the response message to the UE.

In accordance with another aspect of the disclosure, one or more non-transitory computer-readable storage media storing one or more computer programs including computer-executable instruction that, when executed by one or more processors of a user equipment (UE) individually or collectively, cause the UE to perform operations of activating and deactivating of a measurement gap in a communication network system are provided. The operations include receiving, by the UE from a network apparatus, a radio resource control (RRC) configuration message, wherein the RRC configuration message comprises at least one of a measurement gap, or a condition for activation or deactivation of the measurement gap at the UE, determining, by the UE, whether the condition for activation or deactivation of the measurement gap is fulfilled based on the measurement gap being deactivated or activated, transmitting, by the UE, a request message to a network apparatus for activation or deactivation of the measurement gap based on the condition for activation or deactivation of the measurement gap being fulfilled, receiving, by the UE, a response message from the network apparatus for activation or deactivation of the measurement gap, and activating or deactivating, by the UE, the measurement gap based on the response message.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a sequence diagram that illustrates measurement gaps with subsequent mobility according to the related art;

FIG. 2 is a schematic diagram that illustrates a schematic of a user equipment (UE) implemented to carry out a disclosed subject matter according to an embodiment of the disclosure;

FIG. 3 is a schematic diagram that illustrates a schematic of a network apparatus implemented to carry out a disclosed subject matter according to an embodiment of the disclosure;

FIG. 4 is a sequence diagram that illustrates conditional measurement gap activation according to an embodiment of the disclosure;

FIG. 5 is a sequence diagram that illustrates conditional measurement gap deactivation according to an embodiment of the disclosure;

FIG. 6 is a sequence diagram that illustrates a capability for conditional gap activation and deactivation according to an embodiment of the disclosure;

FIG. 7 is a sequence diagram that illustrates activation and deactivation of measurement gaps based on signalling details and behavior of a UE according to an embodiment of the disclosure;

FIG. 8 is a sequence diagram that illustrates an activation of a measurement gap according to an embodiment of the disclosure;

FIG. 9 is a sequence diagram that illustrates deactivation of a measurement gap according to an embodiment of the disclosure;

FIG. 10 is a sequence diagram that illustrates simplified activation of a measurement gap according to an embodiment of the disclosure;

FIG. 11 is a sequence diagram that illustrates simplified deactivation of a measurement gap according to an embodiment of the disclosure;

FIG. 12 is a sequence diagram that illustrates a further simplified activation/deactivation of a measurement gap according to an embodiment of the disclosure;

FIG. 13 is a sequence diagram that illustrates interaction between an OAM and a network apparatus according to an embodiment of the disclosure;

FIG. 14 is a flow diagram that illustrates a method for activation and deactivation of a measurement gap in a communication network system by a UE according to an embodiment of the disclosure; and

FIG. 15 is a flow diagram that illustrates a method for activation and deactivation of a measurement gap in a communication network system by a network apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is existing in the field, embodiments are described and illustrated in terms of blocks that carry out a described function or functions. These blocks, which referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports, such as printed circuit boards, and the like. The circuits constituting a block be implemented by dedicated hardware, or by a processor (for example, a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, or the like. used herein to describe various elements, these elements are not be limited by these terms. These terms are generally used to distinguish one element from another.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

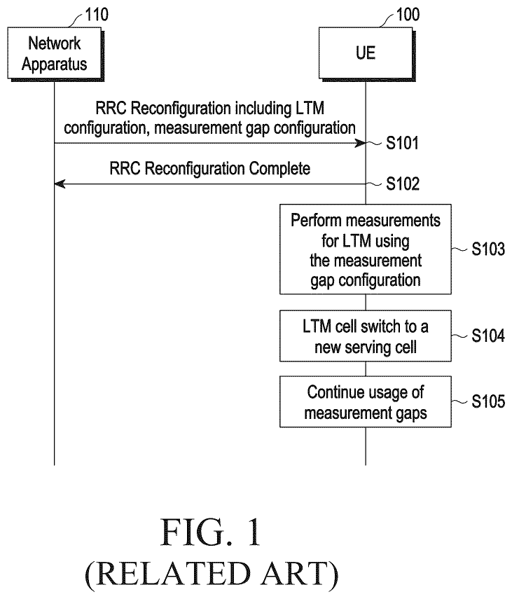

FIG. 1 is a sequence diagram that illustrates measurement gaps with subsequent mobility according to the related art.

Referring to FIG. 1, the sequence diagram includes a UE 100 in communication with a network apparatus 110. At operation S101, the network apparatus 110 sends a RRC reconfiguration including an lower layer triggered mobility (LTM) configuration and measurement gap configuration to the UE 100. At operation S102, the UE 100 transmits a RRC reconfiguration complete to the network apparatus 110. At operation S103, the UE 100 performs measurements for LTM using the measurement gap configuration. At operation S104, the UE 100 performs an LTM cell switch to a new serving cell. At operation S105, the UE 100 continues usage of measurement gaps. 5G NR supports subsequent LTM and subsequent conditional PSCell addition or change (CPAC). The UE 100 can perform LTM or subsequent CPAC (SCPAC) using the stored configuration without another RRC reconfiguration. Sixth generation (6G) aims to retain subsequent LTM and is expected to support subsequent handover. The UE 100 continues the usage of measurement gaps even though measurements or measurement gaps are not required. Thus, a dynamic activation or deactivation of measurement gaps are needed to handle this scenario.

A measurement gap configuration is a technical procedure used in mobile communication networks like long-term evolution (LTE), 5G and 6G. It enables the UE 100 to temporarily suspend its regular communication with the network apparatus 110 to perform measurement activities. These measurements can include serving cell measurements, neighbor cell measurements, or interference measurements. Measurement gaps are crucial for optimizing network performance and handover decisions.

The measurement gap configuration procedure is initiated when specific events require the UE 100 to perform measurements on neighboring cells or some serving cells. These events can include:
Handover preparation: The UE 100 needs to measure signal quality in neighboring cells to determine the best target cell for handover.
Interference measurement: The UE 100 assesses interference levels in the current cell or neighboring cells.
Periodic measurement: The UE 100 periodically measures signal quality for network optimization.

The measurement gaps create gaps in the reception (and transmission) for the UE 100 and affects the throughput, latency and other key performance indicators. Currently, there is no method to limit the measurement gaps to the scenarios where it is needed.

The proposed solution provides a method and system for conditional activation/deactivation of measurement gaps in wireless networks. The disclosure specifically addresses the challenges related to limiting the measurement gaps created during the transmission and the reception in wireless networks. In an embodiment of the disclosure, the network apparatus 110 configures the UE 100 with measurement configuration, the measurement gap configuration (preconfigured measurement gap configuration) and the conditions for activation of the measurement gap configuration. The condition for activation of the measurement gap configuration can be serving cell measurements going below a threshold (serving cell becomes worser than a threshold), similar to the event A2 in NR. The threshold can be based on power, quality, signal to interference-noise ratio (SINR), or the like, i.e., the threshold may be based on reference signal received power (RSRP), reference signal received quality (RSRQ), SINR, and the like. The measurement configuration can contain the measurement object configuration, such as the frequency, reference signal to be measured, measurement report configuration, measurement identity configuration, or the like.

In an embodiment of the disclosure, the network apparatus 110 configures the UE 100 with a condition, such as a condition where the serving cell measurements going below a threshold, similar to the event A2 in NR, and upon the fulfilment of the condition, the UE 100 informs the network apparatus 110 about the condition fulfillment and the network apparatus 110 configures the measurement gap.

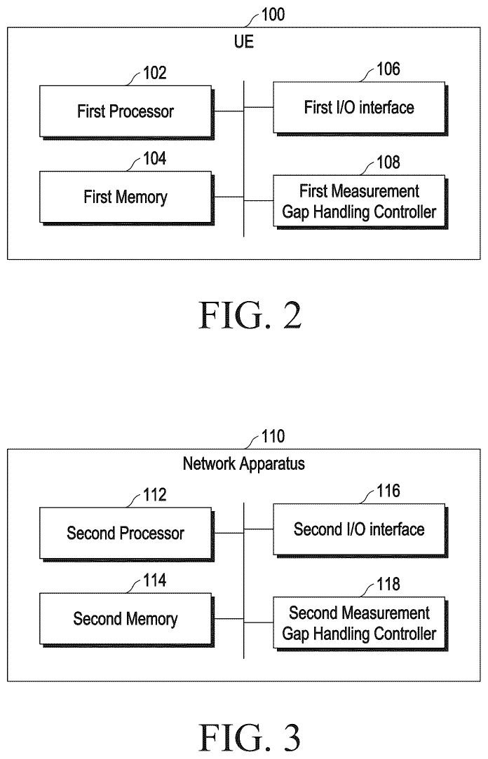

FIG. 2 is a block diagram that illustrates a schematic of the UE 100 implemented to carry out a disclosed subject matter according to an embodiment of the disclosure.

Examples of the UE 100 can include, but are not limited to, consumer electronics (such as mobile phones and smartphones), tablets, wearable devices, computing devices (such as laptops, notebooks, desktops, workstations, or the like), Internet of things (IoT) devices, automotive systems (such as connected cars, autonomous vehicles, vehicle-to-everything (V2X) communication devices, or the like), enterprise devices, such as robotics, specialized equipment (such as medical devices, public safety devices, or the like), media devices (such as gaming consoles, streaming devices, or the like).

Referring to FIG. 2, the UE 100 includes a first processor 102, first memory 104, a first input/output (I/O) interface 106, and a first measurement gap handling controller 108 coupled to the first processor 102 and the first memory 104. The first measurement gap handling controller 108 may be included in the first processor 102. The components are described below.

The first processor 102 communicates with the first memory 104, the first I/O interface 106 and the first measurement gap handling controller 108. The first processor 102 is configured to execute instructions stored in the first memory 104 and to perform various processes. The first processor 102 includes one or a plurality of processors, is a general-purpose processor, such as the CPU, an application processor (AP), or the like, a graphics-only processing unit, such as a graphics processing unit (GPU), a visual processing unit (VPU), and/or an artificial intelligence (AI) dedicated processor, such as a neural processing unit (NPU).

The first memory 104 includes storage locations to be addressable through the first processor 102. The first memory 104 stores the measurement gap, a condition for activation or deactivation of the measurement gap, and the like. The first memory 104 is not limited to volatile memory and/or non-volatile memory. Further, the first memory 104 includes a plurality of computer-readable storage media. The first memory 104 includes non-volatile storage elements. For example, non-volatile storage elements include magnetic hard disks, optical disks, floppy disks, flash memories, or forms of electrically programmable read only memories (EPROMs) or electrically erasable and programmable ROMs (EEPROMs).

The first I/O interface 106 transmits the information between the first memory 104 and external peripheral devices. The peripheral devices are the input-output devices associated with the UE 100. Further, the first measurement gap handling controller 108 communicates with the first I/O interface 106 and the first memory 104. The first measurement gap handling controller 108 is coupled to the first memory 104 and the first processor 102. This coupling allows for efficient data transfer and communication between the components, ensuring that the first measurement gap handling controller 108 can handle activation and deactivation of a measurement gap in a communication network system

The first measurement gap handling controller 108 is an innovative integrated circuit that is implemented in the UE 100. In an embodiment of the disclosure, the structure of such innovative integrated circuit includes a multi-core architecture that enables handling activation and deactivation of a measurement gap in a communication network system. Each core is optimized for specific tasks, such as configuring the measurement gap, determining whether measurement gap activation/deactivation condition is fulfilled, activating/deactivating the measurement gap, and the like. The innovative integrated circuit for the above-mentioned points is made of a combination of analog and digital components designed to enable handling activation and deactivation of a measurement gap in a communication network system. The analog components include a low-noise amplifier and a high-precision analog-to-digital converter to ensure accurate signal processing. The digital components consist of a microcontroller unit (MCU) and a digital signal processor (DSP) that work in tandem to enable handling activation and deactivation of a measurement gap in a communication network system.

FIG. 3 is a schematic diagram that illustrates a schematic of a network apparatus implemented to carry out a disclosed subject matter according to an embodiment of the disclosure.

The network apparatus 110 includes various hardware and software components that facilitate communication between user equipment and network infrastructure. Examples of the network apparatus 110 can include, but is not limited to base stations (such as macro cells, small cells, femtocells, picocells, 6G base station) for wireless communication, Antennas and radio frequency (RF) Units (e.g., multiple input and multiple output (MIMO), beamforming) to enhance signal coverage and data throughput, core network equipment (e.g., mobility management entities (MMEs), serving gateways (S-GWs), packet data network gateways (P-GWs) in fourth generation (4G), access and mobility management functions (AMFs), user plane functions (UPFs) in 5G) for data routing, mobility, and session control, network function virtualization (NFV) and software-defined networking (SDN) for dynamic resource allocation and scalability, edge computing nodes (e.g., multi-access edge computing (MEC) servers) for low-latency processing, backhaul and transport equipment (e.g., fiber-optic links, microwave relays, ethernet switches) to connect base stations to the core network, network management systems (NMS) and operation support systems (OSS) for network configuration, fault management, and optimization, radio network controllers (RNCs) in 3G, distributed units (DUs), and centralized units (CUs) in 5G, network slicing components for virtualized resource allocation, security elements (e.g., firewalls, intrusion detection system (IDS), authentication, authorization, and accounting (AAA) Servers) for secure communication.

Referring to FIG. 3, the network apparatus 110 includes a second processor 112, second memory 114, a second I/O interface 116, and a second measurement gap handling controller 118 coupled to the second processor 112 and the second memory 114. The second measurement gap handling controller 118 may be included in the second processor 112. The components are described below.

The second processor 112 communicate with the second memory 114, the second I/O interface 116 and the second measurement gap handling controller 118. The second processor 112 is configured to execute instructions stored in the second memory 114 and to perform various processes. The second processor 112 includes one or a plurality of processors, is a general-purpose processor, such as the CPU, an application processor (AP), or the like, a graphics-only processing unit, such as a graphics processing unit (GPU), a visual processing unit (VPU), and/or an artificial intelligence (AI) dedicated processor, such as a neural processing unit (NPU).

The second memory 114 includes storage locations to be addressable through the second processor 112. The second memory 114 stores the measurement gap configuration, the condition for activation or deactivation of the measurement gap, and the like. The second memory 114 is not limited to volatile memory and/or non-volatile memory. Further, the second memory 114 includes a plurality of computer-readable storage media. The second memory 114 includes non-volatile storage elements. For example, non-volatile storage elements include magnetic hard disks, optical disks, floppy disks, flash memories, or forms of EPROM or EEPROM memories.

The second I/O interface 116 transmits the information between the second memory 114 and external peripheral devices. The peripheral devices are the input-output devices associated with the network apparatus 110. Further, the second measurement gap handling controller 118 communicates with the second I/O interface 116 and the second memory 114. The second measurement gap handling controller 118 is coupled to the second memory 114 and the second processor 112. This coupling allows for efficient data transfer and communication between the components, ensuring that the second measurement gap handling controller 118 can handle activation and deactivation of a measurement gap in a communication network system

The second measurement gap handling controller 118 is an innovative integrated circuit that is implemented in the network apparatus 110. In an embodiment of the disclosure, the structure of such innovative integrated circuit includes a multi-core architecture that enables handling activation and deactivation of a measurement gap in a communication network system. Each core is optimized for specific tasks, such as generating the measurement gap configuration, generating a response message to activate/deactivate the measurement gap, and the like. The innovative integrated circuit for the above-mentioned points is made of a combination of analog and digital components designed to enable handling activation and deactivation of a measurement gap in a communication network system. The analog components include a low-noise amplifier and a high-precision analog-to-digital converter to ensure accurate signal processing. The digital components consist of a microcontroller unit (MCU) and a digital signal processor (DSP) that work in tandem to enable handling activation and deactivation of a measurement gap in a communication network system.

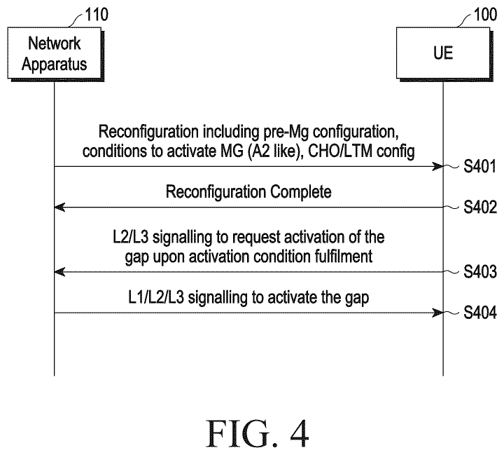

FIG. 4 is a sequence diagram that illustrates conditional measurement gap activation according to an embodiment of the disclosure.

Referring to FIG. 4, the sequence diagram includes the UE 100 in communication with the network apparatus 110 in operations S401, S402, S403, and S404.

In an embodiment of the disclosure, the network apparatus 110 configures the UE 100 with measurement configuration and the measurement gap configuration (preconfigured measurement gap configuration) and the conditions for activation of the measurement gap configuration. Condition for activation of the measurement gap configuration can be serving cell measurements going below a threshold (serving cell becomes worser than a threshold). This can be similar to the event A2 in NR. The threshold can be based on power, quality, signal to interference-noise ratio, or the like, i.e., the threshold may be based on RSRP, RSRQ, SINR, or the like. The measurement configuration can contain the measurement object configuration, such as the frequency, reference signal to be measured, measurement report configuration, measurement identity configuration, or the like. The measurement gap configuration can be either part of measurement configuration or can be configured within the measurement configuration. The serving cell measurements which are considered for the condition can be layer 3 (L3) measurements or L1 measurements, such as the L1 measurements performed for LTM. Measurement gap configuration can include measurement gap length, information to identify the start of the measurement gap in time domain, gap repetition factor, the reference cell which could be used for the measurement gaps. Upon the configuration of measurement gap configuration associated to the conditional activation of measurement gaps, it may be deactivated and may be activated only upon the fulfilment of condition.

The configuration of condition for activation of the measurement gap may include a threshold, a hysteresis and a time to trigger. Hysteresis and time to trigger may be optional.

When the condition is fulfilled, the UE 100 may perform one of the following actions:

The UE 100 activates the measurement gap and starts performing measurements on the inter-frequency neighbors or intra frequency neighbors which need measurement gaps using the measurement gap. The UE 100 also informs the network apparatus 110 that it has activated the measurement gap. The information could be sent on layer1 signalling (such as uplink control information (UCI) in NR), L2 signalling (such as medium access control control element (MAC CE) in NR) or RRC signaling. The network apparatus 110 may acknowledge the information from the UE 100. The information could be sent on layer1 signalling (such as UCI in NR), L2 signalling (such as MAC CE in NR) or RRC signaling. The network apparatus 110 may send the acknowledgment on layer1 signalling (such as UCI in NR), L2 signalling (such as MAC CE in NR) or RRC signaling. In some implementations, the network apparatus 110 may not send a message to acknowledge the activation, but the hybrid automatic repeat request (HARQ)/ARQ acknowledgements help the UE 100 to understand that the information is received properly by the network apparatus 110. If the acknowledgement (including HARQ/ARQ) acknowledgment is not received, the UE 100 may retransmit the information.

The UE 100 requests the network apparatus 110 to activate the measurement gap. The request could be sent on layer1 signalling (such as UCI in NR), L2 signalling (such as MAC CE in NR) or RRC signaling. The network apparatus 110 sends a command (instruction) to activate the measurement gap. The command may be sent on layer1 signalling (such as UCI in NR), L2 signalling (such as MAC CE in NR) or RRC signaling. The network apparatus 110 may send the acknowledgment on layer1 signalling (such as UCI in NR), L2 signalling (such as MAC CE in NR) or RRC signaling. Upon receiving the command, the UE 100 activates the measurement gap and start performing the inter-frequency measurements or the intra frequency measurements which need measurement gaps.

It is possible that the request for activation and deactivation may use the same signaling. For example, same UCI or MAC CE or RRC message may be used to request to activate or deactivate a measurement gap. A field or information element in the UCI or MAC CE or RRC message will inform the network whether the request is for activation or deactivation. Similarly, it is possible that the response/command for activation and deactivation use the same signaling. For example, same downlink control information (DCI) or MAC CE or RRC message may be used by the network apparatus to activate or deactivate a measurement gap at the UE 100. A field or information element in the DCI or MAC CE or RRC message will inform the UE 100 whether the response or command is for activation or deactivation.

In an embodiment of the disclosure, the network apparatus 110 configures the UE 100 with a condition, such as a condition where the serving cell measurements going below a threshold, similar to the event A2 in NR, and upon the fulfilment of the condition, the UE 100 informs the network apparatus 110 about the condition fulfillment and the network apparatus 110 configures the measurement gap.

In an embodiment of the disclosure, the network apparatus 110 configures the UE 100 with a condition, such as a condition where the serving cell measurements going below a threshold. This can be similar to the event A2 in NR. Upon fulfilment of the condition, the UE 100 starts measuring inter-frequency neighbors or intra frequency neighbors which need measurement gaps. In this embodiment of the disclosure, the condition is tied to the measurements than the measurement gaps. i.e., The proposed solution is equally applicable for conditional performance of measurements and not only for the conditional activation of measurement gaps.

In an embodiment of the disclosure, the network apparatus 110 configures the UE 100 with a condition, such as a condition where the serving cell measurements going below a threshold. In other words, when the serving cell measurements become worser than a threshold, the UE 100 requests for activating measurement gap. This prevents the usage of measurement gaps when they are not required, i.e., when there is no probability of mobility as measurement gaps remain deactivated when they are not required. This can be similar to the event A2 in NR. Upon fulfilment of the condition, the UE 100 starts measuring intra-frequency neighbors, or intra-frequency neighbors which need measurement gaps. In this embodiment of the disclosure, the condition is tied to the measurements than the measurement gaps.

In an embodiment of the disclosure, the UE 100 informs the network apparatus 110 whether it is capable of supporting conditional activation of measurement gap (or capable of performing conditional measurements which are related to activating measurement gaps). This may be provided using a per-UE capability in messages for transferring the access stratum capabilities to the network apparatus 110. The network apparatus 110 configures the UE 100 for conditional activation of measurement gap based on the received capabilities.

Network side interactions: In an embodiment of the disclosure, centralized unit (CU) informs distributed unit (DU) about the configuration of preconfigured measurement gaps. CU also may inform the DU about the conditions of activation of preconfigured measurement gaps. Alternatively, the DU may generate the conditions for activation of preconfigured measurement gap and informs the CU and the CU configure the UE 100 with the conditions through RRC messages.

Conditions for configuration of conditional activation of measurement gap: The activation of conditional measurement gap may be configured only after the access stratum security is activated. This ensures that a fake base station is not able to control the activation or deactivation of measurement gaps.

Condition definition of the conditional event for activation of measurement gaps and performing measurements which need gaps: The conditional event for activation of the measurement gap may be associated with an entering condition and a leaving condition.

The UE 100 may consider the entering condition for this event to be satisfied when condition Ax-1, as specified below, is fulfilled for a certain duration timetotrigger (TTT):
Inequality Ax-1 (Entering condition)
Ms+Hys<Thresh

The UE 100 may consider the leaving condition for this event to be satisfied when condition Ax-2, as specified below, is fulfilled for a certain duration timetotrigger (TTT);
Inequality Ax-2 (leaving condition)
Ms−Hys>Thresh

The variables in the formula may be defined as follows:

Ms is the measurement result of the serving cell, not taking into account any offsets.

Hys is the hysteresis parameter for this event (i.e., hysteresis as defined within report configuration for this event).

Thresh is the threshold parameter for this event (i.e., threshold as defined within report configuration for this event).

Ms may be expressed in dBm in case of RSRP, or in dB in case of RSRQ and RS-SINR.

Hys may be expressed in dB.

Thresh may be expressed in the same unit as Ms.

For this measurement, the UE 100 may consider the serving cell indicated by the measurement object associated to this event. In an embodiment of the disclosure, the serving cell which is used for determining the condition triggering is primary cell. In dual connectivity, it is the primary cell of the cellgroup which has configured the conditional measurement gap activation. Upon fulfilment of entering condition, the UE 100 can request for activation of measurement gap. Upon fulfilment of leaving condition, the UE 100 can request for deactivation of measurement gap.

The parameters hysteresis and timetotrigger maybe optional, and if they are not configured, the UE 100 sends request for activating the measurement gap when Ms<Thresh. It may also send a request for deactivating the measurement gap when Ms>Thresh.

Enhancements for the proposed methods for applying to other scenarios: The embodiments can be generalized for applying for other use cases, such as release of a secondary cell or any serving cell or deactivation a secondary cell or any serving cell or handover from a primary cell to a secondary cell or a load balancing handover, or the like.

In an embodiment of the disclosure, the network apparatus 110 configures the UE 100 with an execution condition which is met when a serving cell becomes better than a threshold. Upon the fulfillment of execution condition, the UE 100 performs one or more of actions, such as activating a measurement gap or starting to perform a measurement or the release of a secondary cell or any serving cell or deactivation a secondary cell or any serving cell or handover from a primary cell to a secondary cell or a load balancing handover.

This conditional event may be associated with an entering condition and a leaving condition. The UE 100 may consider the entering condition for this event to be satisfied when condition Ax-1, as specified below, is fulfilled:
Inequality Ax-1 (Entering condition)
Ms+Hys<Thresh

The UE 100 may consider the leaving condition for this event to be satisfied when condition Ax-2, as specified below, is fulfilled;
Inequality Ax-2 (leaving condition)
Ms−Hys>Thresh

The variables in the formula may be defined as follows:

Ms is the measurement result of the serving cell, not taking into account any offsets.

Hys is the hysteresis parameter for this event (i.e., hysteresis as defined within report configuration for this event).

Thresh is the threshold parameter for this event (i.e., threshold as defined within report Configuration for this event).

Ms may be expressed in dBm in case of RSRP, or in dB in case of RSRQ and RS-SINR.

Hys may be expressed in dB.

Thresh may be expressed in the same unit as Ms

For this measurement, the UE 100 may consider the serving cell indicated by the measurement object associated to this event. In an embodiment of the disclosure, the serving cell which is used for determining the condition triggering is primary cell. In dual connectivity, it is the primary cell of the cellgroup which has configured the conditional measurement gap activation.

The disclosed method allows the network apparatus 110 to configure and the UE 100 to perform inter-frequency measurements for a subsequent mobility, such as subsequent LTM or subsequent handover or subsequent CPAC without very high overhead of the unnecessary measurement gap operations.

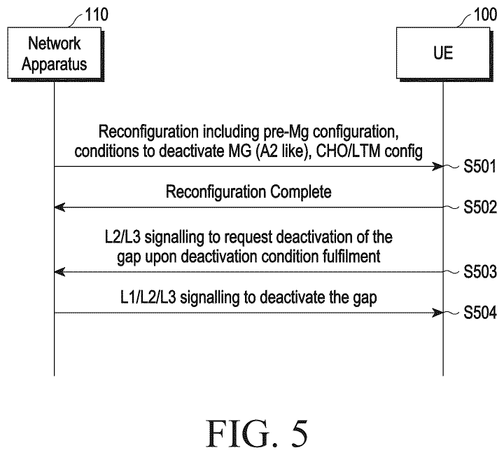

FIG. 5 is a sequence diagram that illustrates conditional measurement gap deactivation according to an embodiment of the disclosure.

Referring to FIG. 5, the UE 100 is in communication with the network apparatus 110.

Conditional deactivation of measurement gap: In operation S501, the network apparatus 110 configures the UE 100 with measurement configuration and the measurement gap configuration (preconfigured measurement gap configuration) and the conditions for deactivation of the measurement gap configuration. In operation S502, the UE 100 transmits a reconfiguration complete message to the network apparatus 110. Condition for deactivation of the measurement gap configuration can be serving cell measurements going above a threshold (serving cell becomes better than a threshold). In other words, when the serving cell measurements become better than a threshold, the UE 100 requests for deactivating measurement gap in operation S503. This prevents the usage of measurement gaps when they are not required, i.e., when there is no probability of mobility as measurement gaps can be deactivated when they are not required. This may be similar to the event A1 in NR. The threshold can be based on power, quality, signal to interference-noise ratio, i.e., the threshold may be based on RSRP, RSRQ, SINR, or the like. The measurement configuration can contain the measurement object configuration, such as the frequency, reference signal to be measured, measurement report configuration, measurement identity configuration, or the like. It can also contain the report configuration which configures the conditional events or measurement events. Condition for deactivation of the measurement gap may be provided in the report configuration and may be sent by the UE 100 to the network apparatus 110 in RRC messages, such as RRC reconfiguration or RRCResume. The measurement gap configuration can be either part of measurement configuration or can be configured within the measurement configuration. The serving cell measurements which are considered for the condition can be L3 measurements or L1 measurements, such as the L1 measurements performed for LTM. Measurement gap configuration can include measurement gap length, information to identify the start of the measurement gap in time domain, gap repetition factor, and the reference cell which could be used for the measurement gaps.

The configuration of condition for deactivation of the measurement gap may include a threshold and optionally a hysteresis and a time to trigger. When the condition is fulfilled, the UE 100 may perform one of the following actions:
1. The UE 100 deactivates the measurement gap and stops performing measurements on the inter-frequency neighbors using the measurement gap. The UE 100 may also inform the network apparatus 110 that it has deactivated the measurement gap. The information could be sent on L1 signalling (similar to uplink control information (UCI) in NR), L2 signalling (similar to MAC CE in NR) or RRC signaling. The network apparatus 110 may acknowledge the information from the UE 100. In operation S504, the network apparatus 110 may send the acknowledgment on layer1 signalling (such as DCI in NR), L2 signalling (such as MAC CE in NR) or RRC signaling.
2. The UE 100 requests the network apparatus 110 to deactivate the measurement gap. The request could be sent on L1 signalling (such as UCI in NR), L2 signalling (such as MAC CE in NR) or RRC signaling. The network apparatus 110 sends a command (instruction) to activate the measurement gap. The command may be sent on layer1 signalling (such as UCI in NR), L2 signalling (such as MAC CE in NR) or RRC signaling. The network apparatus 110 may send the acknowledgment on layer1 signalling (such as downlink control information, DCI in NR), L2 signalling (such as MAC CE in NR) or RRC signaling. Upon receiving the command, the UE 100 deactivates the measurement gaps and stops performing the inter-frequency measurements or the intra frequency measurements which need measurement gaps.

It is possible that the request for activation and deactivation may use the same signaling. For example, same UCI or MAC CE or RRC message may be used to request to activate or deactivate a measurement gap. A field or information element in the UCI or MAC CE or RRC message will inform the network whether the request is for activation or deactivation. Similarly, it is possible that the response/command for activation and deactivation use the same signaling. For example, same DCI or MAC CE or RRC message may be used by the network apparatus 110 to activate or deactivate a measurement gap at the UE 100. A field or information element in the DCI or MAC CE or RRC message will inform the UE 100 whether the response or command is for activation or deactivation.

In an embodiment of the disclosure, a report configuration for conditional event for the deactivation of measurement gaps may be associated to zero or more measurement objects. Association may be provided through measurement identifiers. If it is not associated with a measurement object, the conditional event may be considered as applicable for all the measurement objects.

Capability: In an embodiment of the disclosure, the UE 100 informs the network apparatus 110 whether it is capable of supporting conditional deactivation of measurement gap (or capable of performing conditional measurements for deactivating a measurement gap). This may be provided using a per-UE capability in messages for transferring the access stratum capabilities to the network apparatus 110. The network apparatus 110 configures the UE 100 for conditional deactivation of measurement gap based on the received capabilities. In some scenarios, a single per-UE capability may be used by the UE 100 to inform the network apparatus 110 whether it is capable of supporting conditional activation of measurement gap and conditional deactivation of measurement gap.

Network side interactions: In an embodiment of the disclosure, centralized unit (CU) informs distribute unit (DU) about the configuration of preconfigured measurement gaps. CU also may inform the DU about the conditions of deactivation of preconfigured measurement gaps. Alternatively, the DU may generate the conditions for deactivation of preconfigured measurement gap and informs the CU and the CU configure the UE 100 with the received configuration.

Conditions for configuration of conditional deactivation of measurement gap: The conditions for the deactivation of conditional measurement gap may be configured only after the Access Stratum security is activated. This ensures that a fake base station is not able to control the activation or deactivation of measurement gaps.

Definition of the conditional event for deactivation of measurement gaps: The conditional event for deactivation of the measurement gap may be associated with an entering condition and a leaving condition.

The UE 100 may consider the entering condition for this event to be satisfied when condition Ay-1, as specified below, is fulfilled for a certain duration timetotrigger (TTT);
Inequality Ay-1 (entering condition)
Ms−Hys>Thresh

The UE 100 may consider the leaving condition for this event to be satisfied when condition Ay-2, as specified below, is fulfilled for a certain duration timetotrigger (TTT):
Inequality Ay-2 (leaving condition)
Ms+Hys<Thresh

The variables in the formula may be defined as follows:

Ms is the measurement result of the serving cell, not taking into account any offsets.

Hys is the hysteresis parameter for this event (i.e., hysteresis as defined within report configuration for this event).

Thresh is the threshold parameter for this event (i.e., a1-Threshold as defined within report configuration for this event).

Ms is expressed in dBm in case of RSRP, or in dB in case of RSRQ and RS-SINR.

Hys is expressed in dB.

Thresh is expressed in the same unit as Ms.

For this measurement, the UE 100 may consider the serving cell indicated by the measurement object associated to this event.

Upon fulfilment of entering condition, the UE 100 may request for activation of measurement gap. Upon fulfilment of leaving condition, the UE 100 may request for deactivation of measurement gap.

The parameters hysteresis and timetotrigger maybe optional, and if they are not configured, the UE 100 sends a request for deactivating the measurement gap when Ms>Thresh. It may also send a request for activating the measurement gap when Ms<Thresh.

In an embodiment of the disclosure, there may not be measurement object configured associated to event Ay for deactivation of measurement gap. The measurements could be based on the serving cell, such as SpCell. In an embodiment of the disclosure, the serving cell which is used for determining the condition triggering is primary cell. In dual connectivity, it is the primary cell of the cell group which has configured the conditional measurement gap deactivation.

Enhancements for the proposed methods for applying to other scenarios.

The proposed solution can generalize the embodiments for applying for other use cases, such as the addition of a secondary cell or any serving cell or activation a secondary cell or any serving cell or handover from a primary cell to a secondary cell or a load balancing handover, or the like.

In an embodiment of the disclosure, the network apparatus 110 configures the UE 100 with an execution condition which is met when a serving cell becomes better than a threshold. The UE 100 performs one or more of actions, such as deactivating a measurement gap or stopping a measurement upon the fulfillment of execution condition. Actions could be release of a secondary cell or any serving cell or deactivation a secondary cell or any serving cell or handover from a primary cell to a secondary cell or a load balancing handover.

This conditional event may be associated with an entering condition and a leaving condition. The UE 100 may consider the entering condition for this event to be satisfied when condition Ay-1, as specified below, is fulfilled for a certain duration timetotrigger (TTT);
Inequality Ay-1 (Entering condition)
Ms−Hys>Thresh

The UE 100 can consider the leaving condition for this event to be satisfied when condition Ay-2, as specified below, is fulfilled for a certain duration timetotrigger (TTT);
Inequality Ay-2 (leaving condition)
Ms +Hys <Thresh

The variables in the formula may be defined as follows:

Ms is the measurement result of the serving cell, not taking into account any offsets.

Hys is the hysteresis parameter for this event (i.e., hysteresis as defined within report configuration for this event).

Thresh is the threshold parameter for this event (i.e., a1-Threshold as defined within report configuration for this event).

Ms is expressed in dBm in case of RSRP, or in dB in case of RSRQ and RS-SINR.

Hys is expressed in dB.

Thresh is expressed in the same unit as Ms.

For this measurement of the disclosure, the UE 100 may consider the serving cell indicated by the measurement object associated to this event. In an embodiment of the disclosure, there may not be measurement object configured associated to event Ay for functionalities as described above. The measurements could be based on the serving cell, such as SpCell. In an embodiment of the disclosure, the serving cell which is used for determining the condition triggering is primary cell. In dual connectivity, it is the primary cell of the cell group which has configured the conditional measurement gap deactivation.

Advantages of the proposed solution: This proposed solution has multiple advantages. For example, these methods allow the network apparatus 110 to configure and the UE 100 to perform inter-frequency measurements for a subsequent mobility, such as subsequent LTM or subsequent handover or subsequent CPAC without very high overhead of the unnecessary measurement gap operations. This reduces the throughput degradation and latency degradation due to the measurement gaps in wireless systems.

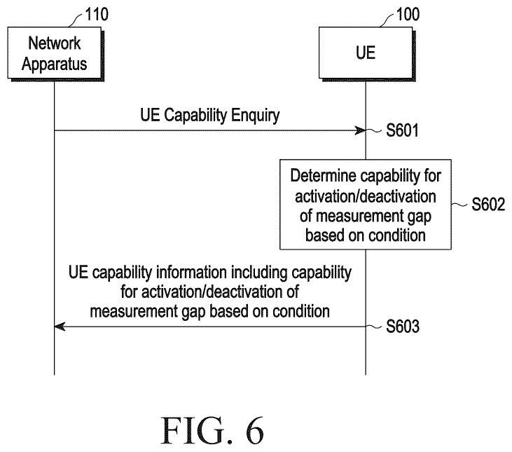

FIG. 6 is a sequence diagram that illustrates a capability exchange for conditional gap activation and deactivation according to an embodiment of the disclosure.

Referring to FIG. 6, the UE 100 is in communication with the network apparatus 110. At operation 601, the network apparatus 110 (for example, gNB) transmits a UE capability enquiry to the UE 100. At operation 602, the UE 100 determines the capability for activation/deactivation of measurement gap based on condition. At operation 603, the UE 100 transmits the UE capability information including capability for activation/deactivation of measurement gap based on condition. The UE 100 reports the capability for conditional activation and deactivation of measurement gaps based on the enquiry from the network apparatus 110. The network apparatus 110 uses this information to decide whether to configure the UE 100 with conditional activation or deactivation of measurement gaps.

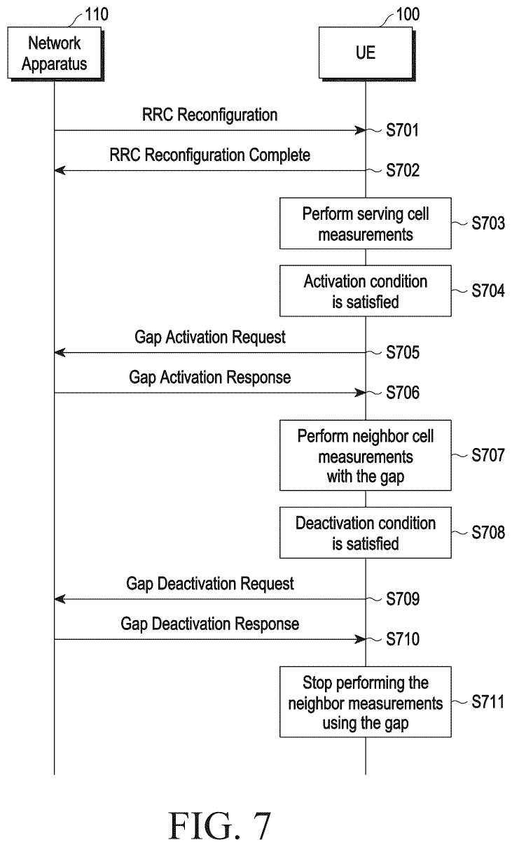

FIG. 7 is a sequence diagram that illustrates activation and deactivation of measurement gaps based on signalling details and behavior of a UE according to an embodiment of the disclosure.

Referring to FIG. 7, the UE 100 is in communication with the network apparatus 110.

In operation 701, the network apparatus 110 transmits a RRC reconfiguration message to the UE 100. In operation 702, the UE 100 then transmits a RRC reconfiguration complete message to the network apparatus 110. In operation 703, the UE 100 performs the serving cell measurements, and the activation condition is satisfied in operation 704. In operation 705 the UE 100 sends a gap activation request to the network apparatus 110. In operation 706, the network apparatus 110 sends a gap activation confirmation to the UE 100. In operation 707, the UE 100 performs neighbor cell measurements with the gap, and the deactivation condition is satisfied in operation 708. In operation 709, the UE 100 sends a gap activation request to the network apparatus 110. In operation 710, the network apparatus 110 sends a gap activation confirmation to the UE 100. In operation 711, the UE 100 then stops performing the neighbor measurements using the gap.

In an embodiment of the disclosure, the network apparatus 110 (for example, 6G base station) configures the UE 100 with measurement configuration, including measurement gap configuration and measurement object configuration/LTM measurement configuration. The UE 100 performs serving cell measurements, which can be either L1 measurements or L3 measurements. The configuration incudes one or more of:
Measurement object configuration includes the frequency, subcarrier spacing, reference signal configuration, cell list, measurement gap identifier, or the like.
LTM configuration, such as LTM candidate configuration including frequency, reference signal configuration, sub carrier spacing, candidate cell identifier, gap identifier, or the like.
Measurement gap configuration including gap length, gap offset, gap repetition factor, gap identifier, gap activation condition and gap deactivation condition.
Gap activation condition includes activation threshold, hysteresis and timetotrigger (TTT). Hysteresis and timetotrigger may be optional. Activation condition and hysteresis can be based on L1 measurements or L3 measurements. TTT is in ms or seconds.
Gap deactivation condition includes deactivation threshold, hysteresis and timetotrigger (TTT). Hysteresis and timetotrigger may be optional. Deactivation condition and hysteresis can be based on L1 measurements or L3 measurements.

Activation condition can be defined as follows: measured value (RSRP/RSRQ/SINR) of serving cell, Ms+hysteresis<activation threshold for duration TTT. When the activation condition is satisfied, the UE 100 sends gap activation request and the network apparatus 110 sends gap activation confirmation, the gap is activated. The UE 100 starts to perform the measurements for the frequencies/cells associated with the gap using the activated gap. Gap activation request/gap activation confirmation in this disclosure typically means measurement gap activation /quest/ measurement gap activation confirmation, though this can be used for any type of gap, such as MultiSim gap or Uplink gap, or the like. Both means the Request to activate a measurement gap and confirmation/response/acknowledgement/command to activate the measurement gap.

Deactivation condition can be defined as follows: measured value (RSRP/RSRQ/SINR) of serving cell, Ms-hysteresis>deactivation threshold for duration TTT. When the deactivation condition is satisfied, the UE 100 sends gap deactivation request and the network apparatus 110 sends gap deactivation confirmation, the gap is deactivated. The UE 100 stops using the gap and performing the measurements for the frequencies associated with the gap. Gap deactivation request/gap deactivation confirmation in this disclosure typically means measurement gap deactivation request/measurement gap deactivation confirmation. Both means the request to deactivate a measurement gap and confirmation/response/acknowledgement/command to deactivate the measurement gap. Measurement gap and gap are synonymously used.

In a simplified option, Hysteresis and TTT in the activation condition and deactivation condition is not provided.

Activation condition: measured value (RSRP/RSRQ/SINR) of serving cell, Ms<Activation Threshold

Deactivation condition: measured value (RSRP/RSRQ/SINR) of serving cell, Ms>Deactivation Threshold

In another simplified option, there may be a single measurement gap instead of multiple gaps, in that case there will be only one activation condition and deactivation condition and the measurement configuration, such as in measurement object configuration or LTM candidate configuration may not be configured with the measurement gap identifier. If the activation condition is satisfied, the UE 100 sends the request to activate the measurement gap and the network apparatus 110 activates the gap and the UE 100 performs the measurements for all the measurements which require gap. If the deactivation condition is satisfied, the UE 100 sends the request to deactivate the measurement gap and the network apparatus 110 deactivates the gap and stops performing corresponding measurements.

In yet another simplified option, the network apparatus 110 configures the UE 100 to report event-based measurements, for example, L3 measurement-based events, such as EventA2 or EventA1 or L1 measurement-based events, such as EventLTM2. Once the event criteria are satisfied, the UE 100 sends the L3 measurement report or L1 measurement report. The network apparatus 110 sends a command to activate the measurement gap.

In an embodiment of the disclosure, the network apparatus 110 may configure the UE 100 with EventLTM2. Once the event is satisfied, the UE 100 may send L1 measurements. The network apparatus 110 may send a request to configure the measurement gap. In this embodiment of the disclosure, preconfigured measurement gap is not necessary. The network apparatus 110 sends measurement gap configuration which is always active upon configuration while receiving LTM2 event. Upon receiving the measurement gap configuration, the measurement gap will be active.

In an additional embodiment of the disclosure, instead of a separate deactivation condition, the leaving condition of the activation can be used for requesting for deactivation of the gap. Similarly, a leaving condition can be defined even for deactivation condition and that can be used for requesting activation of the gap.

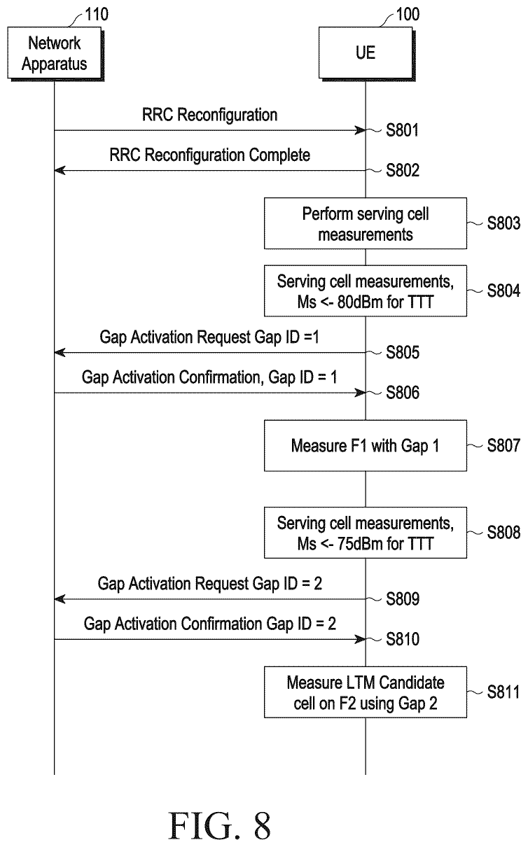

FIG. 8 is a sequence diagram that illustrates activation of a measurement gap according to an embodiment of the disclosure.

Referring to FIG. 8, the UE 100 is in communication with the network apparatus 110.

In operation 801, the network apparatus 110 transmits a RRC reconfiguration message to the UE 100. The UE 100 then transmits a RRC reconfiguration complete message to the network apparatus 110 in operation 802. In operations 803 and 804, the UE 100 performs the serving cell measurements for Ms<−80 dBM for TTT. The UE 100 sends a gap activation request to the network apparatus 110 with a GapID=1 in operation 805. The network apparatus 110 sends a gap activation confirmation to the UE 100 with a GapID=1 in operation 806. The UE 100 measures F1 with Gap 1 in operation 807 and performs the serving cell measurements for Ms<−80 dBM for TTT in operation 808. The UE 100 sends a gap activation request to the network apparatus 110 with a GapID=2 in operation 809. The network apparatus 110 sends a gap activation confirmation to the UE 100 with a GapID=2 in operation 810. The UE 100 then measures the LTM candidate cell 2 on F2 using the Gap 2 in operation 811.
MeasObject ID=1 Frequency=F1 MeasGapID=1
LTM candidate ID=2 Frequency=F2 MeasGapID=2
MeasGapID=1 Activation condition: Activation Threshold1=−90 dBm, Hysteresis=−10 dBm, TimeToTrigger=500 ms
MeasGapID=2 Activation condition: Activation Threshold2=−80 dBm, Hysteresis=−5dBm, TimeToTrigger=1 s
Serving cell on frequency 3

The UE 100 measures the serving frequency and serving cell. If the measured value, Ms is less than −80 dBM (Ms<−80+hysteresis=−10<activation threshold 1 −90 dBm) for timeToTrigger 500 ms, the UE 100 sends request to activate measgapID=1.

The network apparatus 110 confirms the request, and UE 100 activates the measurement gap with ID=1 and starts to measure F1.

The UE 100 continues to measure the serving frequency and serving cell. If the measured value is less than −75 dBM (Ms<−75+hysteresis=−5<activation threshold2−80 dBm) for timeToTrigger 1 second, the UE 100 sends request to activate measgapID=2.

The network apparatus 110 confirms the request, and the UE 100 activates the measurement gap with ID=2 and starts to measure LTM candidate 2 on F2.

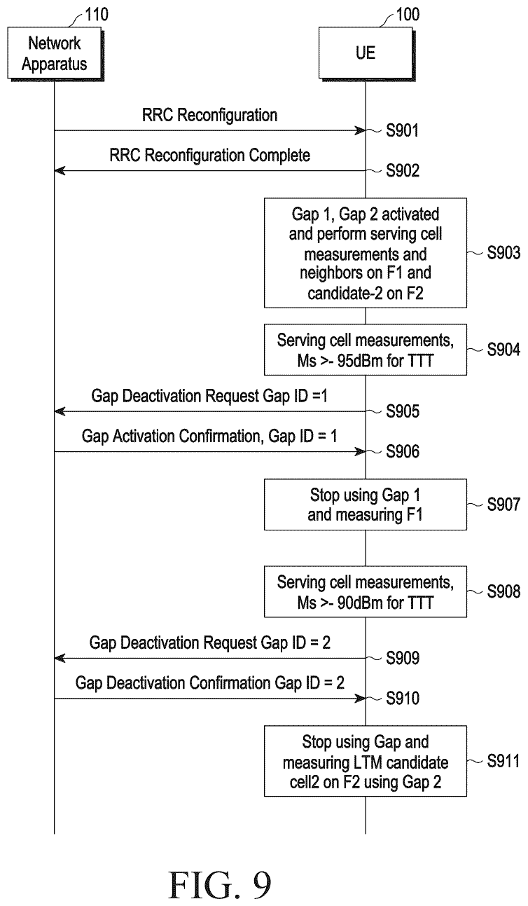

FIG. 9 is a sequence diagram that illustrates deactivation of a measurement gap according to an embodiment of the disclosure.

Referring to FIG. 9, the UE 100 and the network apparatus 110 are in communication with each other with RRC reconfiguration message in operation S901 and RRC reconfiguration complete message in operation S902.
MeasObject ID=1 Frequency=F1 MeasGapID=1
LTM candidate ID=2 Frequency=F2 MeasGapID=2
MeasGapID=1 Deactivation condition: Deactivation Threshold1=−85 dBm, Hysteresis=−10 dBm, TimeToTrigger=500 ms
MeasGapID=2 Deactivation condition: Deactivation Threshold2=−80 dBm, Hysteresis=−10 dBm, TimeToTrigger=1 s
Serving cell on frequency 3

MeasGapID=1 and MeasGapID=2 are activated and the UE 100 is performing measurements on the F1 and LTM candidateID=2 on F2 in operation S903.

In operation S904, the UE 100 measures the serving frequency and serving cell. If the measured value is greater than −95 dBM (Ms>−95 dBm−hysteresis=−10>deactivation threshold 1 −85 dBm) for TimeToTrigger 500 ms, the UE 100 sends request to deactivate measgapID=1 in operation S905.

In operation S906, the network apparatus 110 confirms the request, and UE 100 deactivates the measurement gap with ID=1 and the UE 100 stops measuring F1 in operation S907.

The UE 100 continues to measure the serving frequency and serving cell. If the measured value is greater than −90 dBM (Ms>−90−hysteresis=−10 >Deactivation threshold2 −80dBm) for TimeToTrigger 1 second in operation S908, the UE 100 sends request to deactivate measgapID=2 in operation S909.

The network apparatus 110 confirms the request in operation S910, and the UE 100 deactivates the measurement gap with ID=2 and stops measuring LTM candidate 2 on F1 in operation S911.

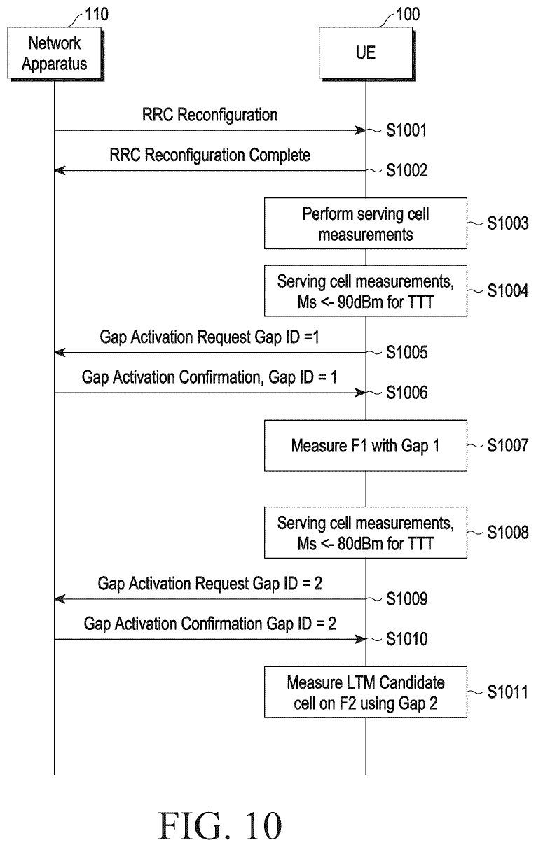

FIG. 10 is a sequence diagram that illustrates a simplified activation of a measurement gap according to an embodiment of the disclosure.

Referring to FIG. 10, the UE 100 and the network apparatus 110 are in communication with each other with RRC reconfiguration message in operation S1001 and RRC reconfiguration complete message in operation S1002.
MeasObject ID=1 Frequency=F1 MeasGapID=1
LTM candidate ID=2 Frequency=F2 MeasGapID=2
MeasGapID=1 Activation condition: Activation Threshold1=−90 dBm
MeasGapID=2 Activation condition: Activation Threshold2=−80 dBm
Serving cell on frequency 3

In operation S1003, the UE 100 measures the serving frequency and serving cell. If the measured value is less than −90 dBM in operation S1004, the UE 100 sends request to activate measgapID=1 in operation S1005.

In operation S1006, the network apparatus 110 confirms the request, and the UE 100 activates the measurement gap with ID=1 and starts to measure F1 in operation S1007.

The UE 100 continues to measure the serving frequency and serving cell. If the measured value is less than −80 dBM in operation S1008, the UE 100 sends request to activate measgapID=2 in operation S1009.

The network apparatus 110 confirms the request in operation S1010, and the UE 100 activates the measurement gap with ID=2 and starts to measure LTM candidate 2 on F2 in operation S1011.

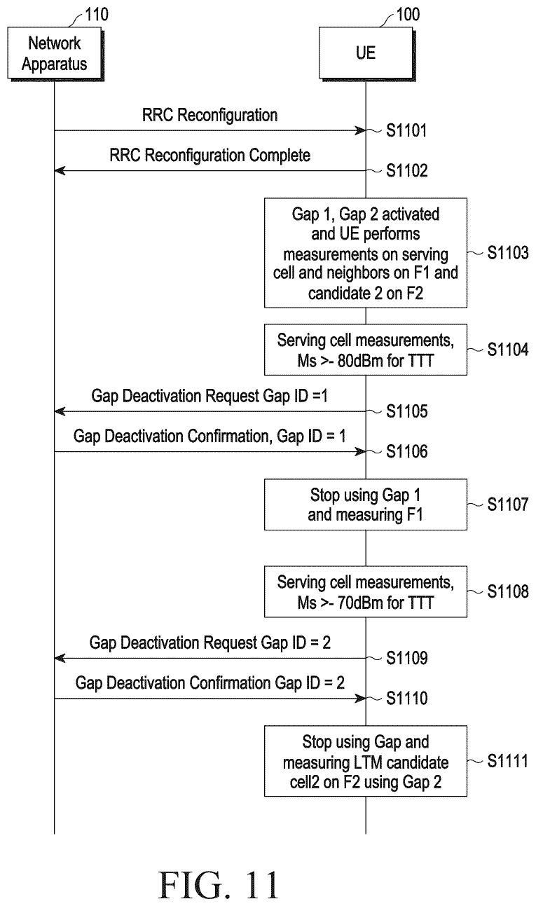

FIG. 11 is a sequence diagram that illustrates a simplified deactivation of a measurement gap according to an embodiment of the disclosure.

Referring to FIG. 11, the UE 100 and the network apparatus 110 are in communication with each other with RRC reconfiguration message in operation S1101 and RRC reconfiguration complete message in operation S1102.
MeasObject ID=1 Frequency=F1 MeasGapID=1
LTM candidate ID=2 Frequency=F2 MeasGapID=2
MeasGapID=1 Deactivation condition: Deactivation Threshold1=−80 dBm
MeasGapID=2 Deactivation condition: Deactivation Threshold2=−70 dBm
Serving cell on frequency 3
Gap1 and Gap2 are activated and the UE 100 performs measurements on serving cell and neighbour cells on F1 and LTM candidate cell 2 on F2.

MeasGapID=1 and MeasGapID=2 are activated and the UE 100 is performing measurements on the F1 and LTM candidateID=2 on F2 in operation S1103.

In operation S1104, the UE 100 measures the serving frequency and serving cell. If the measured value is greater than −80 dBM, the UE 100 sends request to deactivate measgapID=1 in operation S1105.

In operation S1106, the network apparatus 110 confirms the request, and the UE 100 deactivates the measurement gap with ID=1 and the UE 100 stops measuring F1 in operation S1107.

The UE 100 continues to measure the serving frequency and serving cell. If the measured value is greater than −70 dBM in operation S1108, the UE 100 sends request to deactivate measgapID=2 in operation S1109.

The network apparatus 110 confirms the request in operation S1110, and the UE 100 deactivates the measurement gap with ID=2 and stops measuring LTM candidate 2 on F1 in operation S1111.

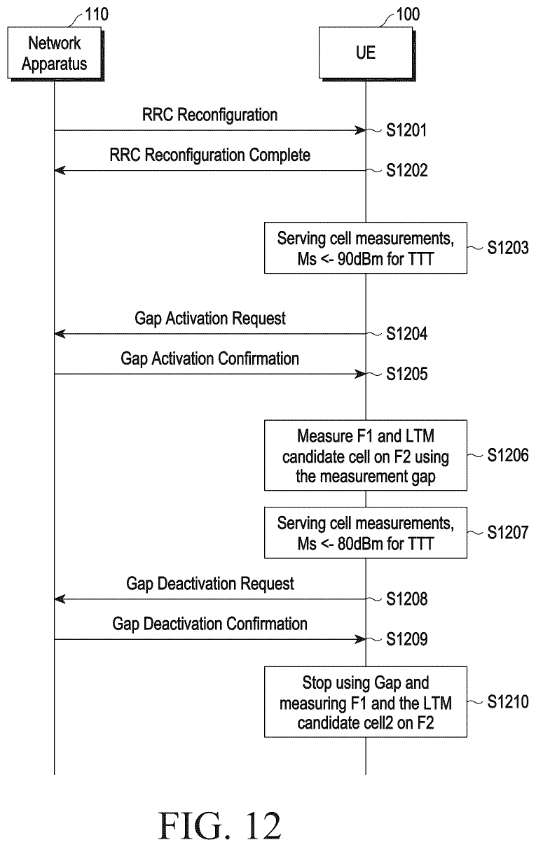

FIG. 12 is a sequence diagram that illustrates a further simplified activation/deactivation of a measurement gap according to an embodiment of the disclosure.

Referring to FIG. 12, the UE 100 and the network apparatus 110 are in communication with each other with RRC reconfiguration message in operation S1201 and RRC reconfiguration complete message in operation S1202.
MeasObject ID=1 Frequency=F1
LTM candidate ID=2 Frequency=F2
Single measurement gap, Activation condition: Activation Threshold1=−90 dBm, Deactivation Threshold =−80 dBm
Serving cell on frequency 3

In operation S1203, the UE 100 measures the serving frequency and serving cell. If the measured value is less than −90 dBM, the UE 100 sends request to activate measurement gap in operation S1204.

In operation S1205, the network apparatus 110 confirms the request, and the UE 100 activates the measurement and starts to measure F1 and LTM candidate cell Cell2 on Freq2 in operation S1206.

The UE 100 continues to measure the serving frequency and serving cell. If the measured value is greater than −80 dBM in operation S1207, the UE 100 sends request to deactivate measgap in operation S1208.

The network apparatus 110 confirms the request in operation S1209, and the UE 100 deactivates the measurement gap and stops to measure F1 and LTM candidate 2 on F1 in operation S1210.

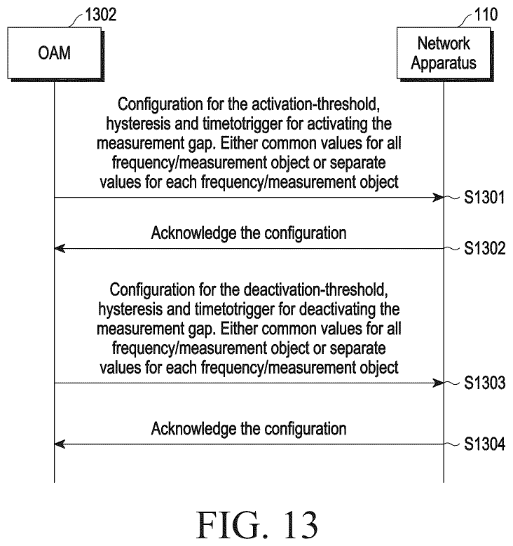

FIG. 13 is a sequence diagram that illustrates interaction between an OAM and a network apparatus according to an embodiment of the disclosure.

Referring to FIG. 13, the OAM 1302 and the network apparatus 110 are in communication with each other as illustrated in operations S1301, S1302, S1303, and S1304. The network apparatus 110 (for example, 6G base station) receives configuration of conditional activation or deactivation of measurement gaps from an OAM 1302.

The configuration incudes one or more of:
Activation thresholds, hysteresis and timetotrigger for conditional activation.
Deactivation thresholds, hysteresis and timetotrigger for conditional deactivation.

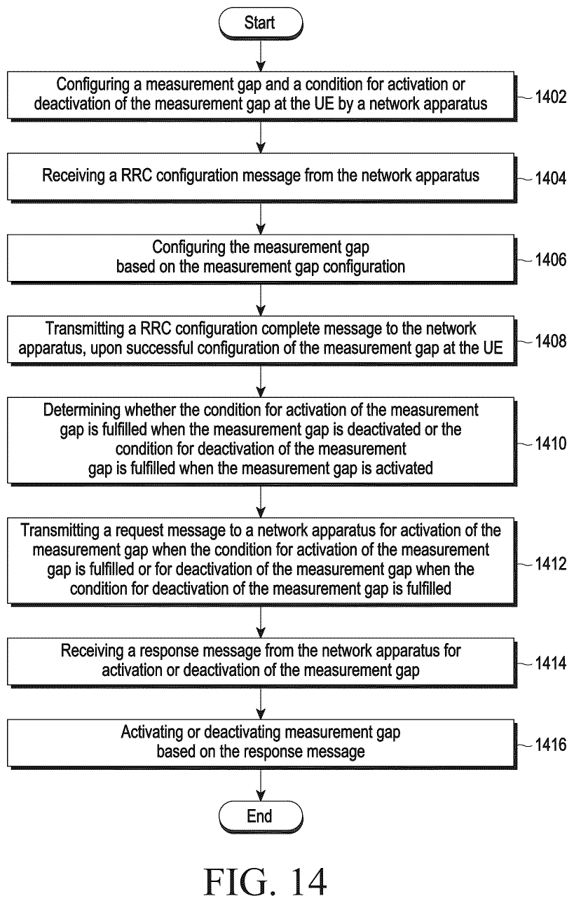

FIG. 14 is a flow diagram that illustrates a method for activation and deactivation of a measurement gap in a communication network system by a UE according to an embodiment of the disclosure.

Referring to FIG. 14, the method includes operations 1402 to 1416. Each operation is described below.

At operation 1402, the method includes configuring by the UE 100 a measurement gap and a condition for activation or deactivation of the measurement gap at the UE 100 by the network apparatus 110. At operation 1404, the method includes receiving by the UE 100 a RRC configuration message from the network apparatus 110. The RRC configuration message includes a measurement gap configuration, the condition for activation of the measurement gap, a condition for deactivation of the measurement gap at the UE 100, and the like. At operation 1406, the measurement gap is configured based on the measurement gap configuration. At operation 1408, the method includes transmitting by the UE 100 a RRC configuration complete message to the network apparatus 110. The RRC configuration complete message is transmitted upon successful configuration of the measurement gap at the UE 100.

At operation 1410, the method includes determining by the UE 100 whether the condition for activation of the measurement gap is fulfilled when the measurement gap is deactivated or the condition for deactivation of the measurement gap is fulfilled when the measurement gap is activated. The condition for activation of the measurement gap includes at least one of:
a sum of measurement result parameter (Ms) of a serving cell and a first hysteresis parameter (Hys1) being lesser than a first threshold (Thresh1) for a first duration TimeToTrigger (TTT1),
measurement result parameter (Ms) of a serving cell being lesser than a threshold,
a sum of measurement result parameter (Ms) of a serving cell and a second hysteresis parameter (Hys2) being lesser than a second threshold (Thresh2) for a second duration TimeToTrigger (TTT2)

The condition for deactivation of the measurement gap includes at least one of:
a difference of measurement result parameter (Ms) of a serving cell and a first hysteresis parameter (Hys1) being greater than a first threshold (Thresh1) for a first duration TimeToTrigger (TTT1)
measurement result parameter (Ms) of a serving cell being greater than a threshold (Thresh3)
a difference of measurement result parameter (Ms) of a serving cell and a second hysteresis parameter (Hys2) being lesser than a second threshold (Thresh2) for a second duration TimeToTrigger (TTT2).

(Thresh1, TTT1, Hys1) and (Thresh2, TTT2, Hys2) may be configured together or only one of them may be used at a time depending on network implementation. They may be based on L3 measurements or L1 measurements. Thresh3 is used without hysteresis or timetotriger value.

At operation 1412, the method includes transmitting by the UE 100 a request message to the network apparatus 110 for activation of the measurement gap when the condition for activation of the measurement gap is fulfilled or for deactivation of the measurement gap when the condition for deactivation of the measurement gap is fulfilled. The request message includes at least one of a L1 signalling message, a L2 signalling message, and a L3 signalling message.

At operation 1414, the method includes receiving by the UE 100 a response message from the network apparatus 110 for activation or deactivation of the measurement gap. The response message includes at least one of a L1 signalling message, a L2 signalling message, and a L3 signalling message. At operation 1416, the method includes activating or deactivating measurement gap based on the response message.

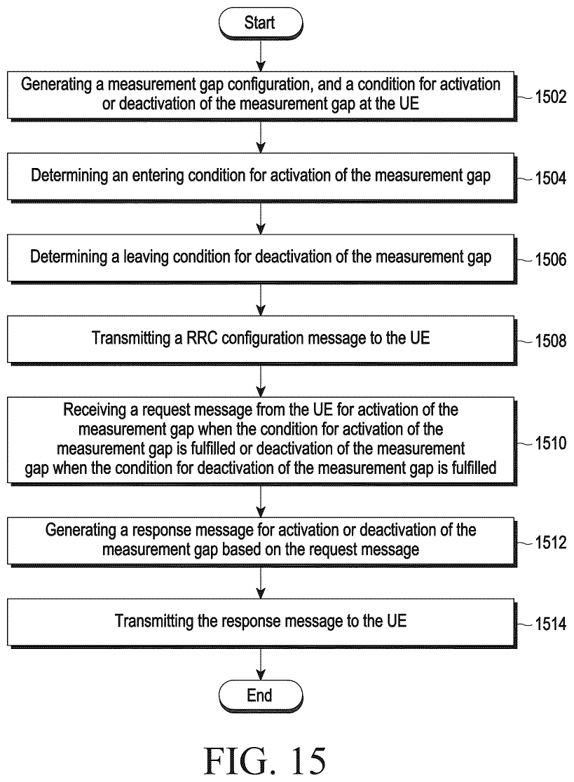

FIG. 15 is a flow diagram that illustrates a method for activation and deactivation of a measurement gap in a communication network system by a network apparatus according to an embodiment of the disclosure.

Referring to FIG. 15, the method includes operations 1502 to 1514. Each operation is described below.

At operation 1502, the method includes generating by the network apparatus 110 a measurement gap configuration, and a condition for activation or deactivation of the measurement gap at the UE 100. At operation 1504, the method includes determining by the network apparatus 110 an entering condition for activation of the measurement gap. The entering condition includes a combination of a measurement result parameter (Ms) of a serving cell and a hysteresis parameter (Hys) for an event being greater than a threshold (Thresh) for the event. At operation 1506, the method includes determining by the network apparatus 110 a leaving condition for deactivation of the measurement gap. The leaving condition is defined by a difference between the measurement result parameter (Ms) and the hysteresis parameter (Hys) being greater than the threshold (Thresh).

At operation 1508, the method includes transmitting by the network apparatus 110 a RRC configuration message to the UE 100. The RRC configuration message includes at least one of the measurement gap configuration, and a condition for activation or deactivation of the measurement gap at the UE 100.

At operation 1510, the method includes receiving by the network apparatus 110 a request message from the UE 100 for activation of the measurement gap when the condition for activation of the measurement gap is fulfilled or deactivation of the measurement gap when the condition for deactivation of the measurement gap is fulfilled.

At operation 1512, the method includes generating by the network apparatus 110 a response message for activation or deactivation of the measurement gap based on the request message. At operation 1514, the method includes transmitting by the network apparatus 110 the response message to the UE 100.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for activation and deactivation of a measurement gap in a communication network system, the method comprising:
receiving, by a user equipment (UE) from a network apparatus, a radio resource control (RRC) configuration message, wherein the RRC configuration message comprises at least one of a measurement gap, or a condition for activation or deactivation of the measurement gap at the UE;
determining, by the UE, whether the condition for activation or deactivation of the measurement gap is fulfilled based on the measurement gap being deactivated or activated;
transmitting, by the UE to the network apparatus, a request message for activation or deactivation of the measurement gap based on the condition for activation or deactivation of the measurement gap being fulfilled;
receiving, by the UE from the network apparatus, a response message for activation or deactivation of the measurement gap based on the request message; and
activating or deactivating, by the UE, the measurement gap based on the response message.

2. The method of claim 1,
wherein the request message comprises at least one of a layer 1 (L1) signalling message, a layer 2 (L2) signalling message, or a layer 3 (L3) signalling message, and
wherein the response message comprises at least one of a L1 signalling message, a L2 signalling message, or a L3 signalling message.

3. The method of claim 1, further comprising:
configuring, by the UE, the measurement gap based on the measurement gap configuration; and
transmitting, by the UE, a RRC configuration complete message to the network apparatus, upon successful configuration of the measurement gap.

4. The method of claim 1, wherein the condition for activation of the measurement gap comprises at least one of:
a sum of measurement result parameter (Ms) of a serving cell and a first hysteresis parameter (Hys1) being lesser than a first threshold (Thresh1) for a first duration TimeToTrigger (TTT1);
measurement result parameter (Ms) of a serving cell being lesser than a third threshold (Thresh3); or
a sum of measurement result parameter (Ms) of a serving cell and a second hysteresis parameter (Hys2) being lesser than a second threshold (Thresh2) for a second duration TimeToTrigger (TTT2).

5. The method of claim 1, wherein the condition for deactivation of the measurement gap comprises at least one of:
a difference of measurement result parameter (Ms) of a serving cell and a first hysteresis parameter (Hys1) being greater than a first threshold (Thresh1) for a first duration TimeToTrigger (TTT1);
measurement result parameter (Ms) of a serving cell being greater than a third threshold (Thresh3); or
a difference of measurement result parameter (Ms) of a serving cell and a second hysteresis parameter (Hys2) being greater than a second threshold (Thresh2) for a second duration TimeToTrigger (TTT2).

6. The method of claim 4, wherein the measurement result parameter (Ms) is the measurement result of the serving cell, and
wherein the first threshold (Thresh1), the second threshold (Thresh2), and the third threshold (Thresh3) are based on layer 1 measurements or layer 3 measurements.

7. The method of claim 1, wherein the UE informs a capability for evaluating the condition for activating or deactivating of the measurement gap based on the RRC configuration message.

8. A method for activation and deactivation of a measurement gap in a communication network system, the method comprising:
generating, by a network apparatus, a measurement gap configuration, and a condition for activation or deactivation of the measurement gap at a user equipment (UE);
transmitting, by the network apparatus, a radio resource control (RRC) configuration message to the UE, wherein the RRC configuration message comprises at least one of the measurement gap configuration, or the condition for activation or deactivation of the measurement gap at the UE;
receiving, by the network apparatus from the UE, a request message for activation or deactivation of the measurement gap based on the condition for activation or deactivation of the measurement gap being fulfilled;
generating, by the network apparatus, a response message for activation or deactivation of the measurement gap based on the request message; and
transmitting, by the network apparatus, the response message to the UE.

9. The method of claim 8,
wherein the request message comprises at least one of a layer 1 (L1) signalling message, a layer 2 (L2) signalling message, or a layer 3 (L3) signalling message, and
wherein the response message comprises at least one of a L1 signalling message, a L2 signalling message, or a L3 signalling message.

10. The method of claim 8, wherein the condition for activation of the measurement gap comprises at least one of:
a sum of measurement result parameter (Ms) of a serving cell and a first hysteresis parameter (Hys1) being lesser than a first threshold (Thresh1) for a first duration TimeToTrigger (TTT1);
measurement result parameter (Ms) of a serving cell being lesser than a third threshold (Thresh3); or
a sum of measurement result parameter (Ms) of a serving cell and a second hysteresis parameter (Hys2) being lesser than a second threshold (Thresh2) for a second duration TimeToTrigger (TTT2).

11. The method of claim 8, wherein the condition for deactivation of the measurement gap comprises at least one of:
a difference of measurement result parameter (Ms) of a serving cell and a first hysteresis parameter (Hys1) being greater than a first threshold (Thresh1) for a first duration TimeToTrigger (TTT1);
measurement result parameter (Ms) of a serving cell being greater than a third threshold (Thresh3); or
a difference of measurement result parameter (Ms) of a serving cell and a second hysteresis parameter (Hys2) being greater than a second threshold (Thresh2) for a second duration TimeToTrigger (TTT2).

12. The method of claim 10, wherein the measurement result parameter (Ms) is the measurement result of the serving cell, and
wherein the first threshold (Thresh1), the second threshold (Thresh2), and the third threshold (Thresh3) are based on layer 1 measurements or layer 3 measurements.

13. The method of claim 10, further comprising:
receiving, from the UE, a capability for evaluating the condition for activating or deactivating of the measurement gap based on the RRC configuration message.

14. A user equipment (UE) for activation and deactivation of a measurement gap in a communication network system, the UE comprising:
memory, comprising one or more storage media, storing instructions; and
at least one processor communicatively coupled to the memory,
wherein the instructions, when executed by the at least one processor, cause the UE to:
receive, from a network apparatus, a radio resource control (RRC) configuration message, wherein the RRC configuration message comprises at least one of a measurement gap, or a condition for activation or deactivation of the measurement gap at the UE,
determine whether the condition for activation or deactivation of the measurement gap is fulfilled based on the measurement gap being deactivated or activated,
transmit a request message to a network apparatus for activation or deactivation of the measurement gap based on the condition for activation or deactivation of the measurement gap being fulfilled,
receive a response message from the network apparatus for activation or deactivation of the measurement gap based on the request message, and
activate or deactivate the measurement gap based on the response message.

15. The UE of claim 14,
wherein the request message comprises at least one of a layer 1 (L1) signalling message, a layer 2 (L2) signalling message, or a layer 3 (L3) signalling message, and
wherein the response message comprises at least one of a L1 signalling message, a L2 signalling message, or a L3 signalling message.

16. The UE of claim 14, wherein the instructions, when executed by the at least one processor, further cause the UE to:
receive a radio resource control (RRC) configuration message from the network apparatus, wherein the RRC configuration message comprises at least one of a measurement gap configuration, or the condition for activation or deactivation of the measurement gap,
configure the measurement gap based on the measurement gap configuration, and
transmit a RRC configuration complete message to the network apparatus, upon successful configuration of the measurement gap.

17. The UE of claim 14, wherein the condition for activation of the measurement gap comprises at least one of:
a sum of measurement result parameter (Ms) of a serving cell and a first hysteresis parameter (Hys1) being lesser than a first threshold (Thresh1) for a first duration TimeToTrigger (TTT1);
measurement result parameter (Ms) of a serving cell being lesser than a third threshold (Thresh3); or
a sum of measurement result parameter (Ms) of a serving cell and a second hysteresis parameter (Hys2) being lesser than a second threshold (Thresh2) for a second duration TimeToTrigger (TTT2).

18. The UE of claim 14, wherein the condition for deactivation of the measurement gap comprises at least one of:
a difference of measurement result parameter (Ms) of a serving cell and a first hysteresis parameter (Hys1) being greater than a first threshold (Thresh1) for a first duration TimeToTrigger (TTT1);
measurement result parameter (Ms) of a serving cell being greater than a third threshold (Thresh3); or
a difference of measurement result parameter (Ms) of a serving cell and a second hysteresis parameter (Hys2) being greater than a second threshold (Thresh2) for a second duration TimeToTrigger (TTT2).

19. The UE of claim 17, wherein the measurement result parameter (Ms) is the measurement result of the serving cell, and
wherein the first threshold (Thresh1), the second threshold (Thresh2), and the third threshold (Thresh3) are based on layer1 measurements or layer 3 measurements.

20. The UE of claim 14, wherein the instructions, when executed by the at least one processor, further cause the UE to inform a capability for evaluating the condition for activating or deactivating of the measurement gap based on the RRC configuration message.
